(19) United States
(12) Patent Application Publication
(10) Pub. No.: US 2010/0153724 A1
(43) Pub. Date: Jun. 17, 2010

(54) SYSTEM AND METHOD FOR A KEY BLOCK BASED AUTHENTICATION

(75) Inventor: Antonius Adriaan Maria Staring, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,276

(22) PCT Filed: Jun. 26, 2006
(86) PCT No.: PCT/IB06/52082

§ 371 Date: Dec. 20, 2007

(30) Foreign Application Priority Data
Jun. 29, 2005 (EP) 05105834.5

(51) Int. Cl. H04L 9/32

(52) U.S. Cl. 713/169

(57) ABSTRACT

The present invention relates to a system (70, 80) and a method for a key block based authentication comprising a plurality of drive units (3) comprising a plurality of subsets, wherein a drive unit (3) has a set of node keys (KN_{d}) and an identifier (ID_{d}) indicating the subsets said drive unit (3) is part of and wherein an application unit (1) has a key block (AKB). In order to allow identification of a hacked drive unit (3) in order to revoke the hacked drive unit (3) from said key block based authentication, wherein said system is to a large extent compatible with existing systems and methods for a key block based authentication, a system is proposed comprising: —a plurality of drive units (3) comprising a plurality of subsets, wherein a drive unit (3) has a set of node keys (KN_{d}) and an identifier (ID_{d}) indicating the subsets said drive unit (3) is part of, —an application unit (1) having a key block (AKB) comprising a plurality of pairs of authorization and authentication keys (KAₓ, KRₐᵤₜₕₓ), wherein each pair of keys is associated with one of said subsets, —a communication means (72) for submitting said identifier (ID_{d}) from said drive unit (3) to said application unit (1) and for submitting an authorization key (KAₓ) from said application unit (1) to said drive unit (3), and—an authentication means (54) for authenticating said drive unit (3) and said application unit (1) by means of a pair of keys, wherein said application unit (1) comprises a selecting means (62) for selecting said pair of keys from said key block (AKB) corresponding to said identifier (ID_{d}), wherein said drive unit (3) comprises a decoding means (52) for deriving said authentication key (KRₐᵤₜₕₓ) of said pair of keys from said authorization key (KAₓ) of said pair of keys by means of said set of node keys (KN_{d}).

The present invention relates to a system and a method for a key block based authentication comprising a plurality of drive units comprising a plurality of subsets, wherein a drive unit has a set of node keys and an identifier indicating the subsets said drive unit is part of and wherein an application unit has a key block.

Key block based authentication protocols are well known and are used between, e.g., an optical disc drive and a software application running on a host computer system. According to the Video Content Protection System VCPS (cf. http://www.licensing.philips.com/vcps) an authentication protocol has to be executed by an application with a drive in order to get access to a VCPS protected disc. As specified in the VCPS specification (Version 1.1 and lower), the application contains an application key block (AKB) and optionally a pre-computed copy of a root key KRᵣₒₒₜ that is encoded in the AKB. The application may also dynamically compute KRᵣₒₒₜ from the AKB using its device ID and its set of node keys KNₕ. Typically, each application contains an AKB with a personalized KRᵣₒₒₜ.

Unfortunately, dynamic computation of KRᵣₒₒₜ in the application renders all applications vulnerable to a key publishing hack even if only a single application is hacked. The reason for this vulnerability is that a hacker can use the node keys KNₕ extracted from the hacked application to determine the root key KRᵣₒₒₜ that is contained in the AKBs of all other applications, even if those applications contain personalized AKBs with unique root keys KRᵣₒₒₜ. Therefore, the hacker can publish a database that contains all root keys KRᵣₒₒₜ without revealing the identity of the hacked application (i.e. the set of node keys KNₕ used to construct the database). As a result, the hack remains open for the general public, while the hacked application cannot be identified and thus cannot be revoked.

A number of solutions that mitigate this key publishing hack are known. A first solution is to construct the AKB in such a manner that it does not authorize any other application than the one in which it is contained. Effectively, this means that the AKB “revokes” those other applications (in addition to one or more drives). Therefore, a hacker can not use the node keys KNₕ of one application to determine the KRᵣₒₒₜ encoded in the AKB of another application. A second solution is to equip an application with an AKB and the associated root key KRᵣₒₒₜ, but not with a set of node keys KNₕ required to decode the AKB.

For VCPS (version 1.2) a mixture of these solutions has been adopted, because VCPS applications require a set of node keys KNₕ to decode another key block (namely the disc key block DKB), and all KNₕ are chosen from the same key space. Here, the AKB “revokes” all applications, including the application that owns the AKB, so that its KNₕ cannot be used to decode KRᵣₒₒₜ from the AKB.

The above solutions effectively mitigate the key publishing hack that may result from a hacked application. The reason is that these solutions force the hacker to publish data that identify the hacked application (namely KRᵣₒₒₜ) in order to open up the hack to the general public. Consequently, it becomes possible to identify and to revoke the hacked application.

It has to be noted that such a revocation of the hacked application is effected through other means than the AKB. For example, VCPS revokes applications through the DKBs distributed on new blank media.

In a threat model which assumes that hardware devices will not be hacked, the above solutions may be sufficient. However, a more realistic threat model assumes that hardware devices will be hacked as well, albeit at a substantially lower rate. Whereas the key publishing hack resulting from hacked applications might be resolved by the above solutions, in this model there now also appears a vulnerability to a key publishing hack that results from hacked drives. In this case, the hacker uses the node keys KN_{d} extracted from a drive to construct a database of the root keys KRᵣₒₒₜ of all applications. And as in the former case, the hacker does not reveal the identity of the revoked drive, so that an identification and a subsequent revocation is not possible.

It is therefore an object of the present invention to provide a system and a method for a key block based authentication comprising a plurality of drive units comprising a plurality of subsets, wherein a drive unit has a set of node keys and an identifier indicating the subsets said drive unit is part of and wherein an application unit has a key block, which allow to identify a hacked drive unit in order to revoke the hacked drive unit from said key block based authentication, wherein said system and said method are to a large extent compatible with existing systems and methods for a key block based authentication.

The object is achieved according to the present invention by a system for a key block based authentication comprising:

a plurality of drive units comprising a plurality of subsets, wherein a drive unit has a set of node keys and an identifier indicating the subsets said drive unit is part of,

an application unit having a key block comprising a plurality of pairs of authorization and authentication keys, wherein each pair of keys is associated with one of said subsets,

a communication means for submitting said identifier from said drive unit to said application unit and for submitting an authorization key from said application unit to said drive unit, and

an authentication means for authenticating said drive unit and said application means by means of a pair of keys,

wherein said application unit comprises a selecting means for selecting a pair of keys from said key block corresponding to said identifier,
wherein said drive unit comprises a first decoding means for deriving said authentication key of said pair of keys from said authorization key of said pair of keys by means of said set of node keys.

The invention also relates to a drive unit as claimed in claim 9 comprising

a set of node keys,

an identifier indicating the subsets said drive unit is part of,

a communication means for submitting said identifier to said application unit and for receiving an authorization key from said application unit,

a decoding means for deriving an authentication key from said authorization key by means of said set of node keys, and

an authentication means for authenticating said application unit by means of said authentication key

and to an application unit as claimed in claim 10 comprising

a key block comprising a plurality of pairs of authorization and authentication keys, wherein each pair of keys is associated with one of said subsets of said drive units,

a communication means for receiving an identifier from a drive unit and for submitting an authorization key to said drive unit,

a selecting means for selecting a pair of keys from said key block corresponding to said identifier,

an authentication means for authenticating said drive unit by means of an authentication key.

A method for a key block based authentication corresponding to the system is defined in claim 11. This method can be implemented on a computer by a computer program comprising computer program code means for causing a computer to perform the steps of said method when said computer program is run on a computer.

The invention is based on the insight that a link between the authentication key and the drive unit for which this authentication key is valid allows to identify the hacked drive unit from which a published authentication key is taken. Since it is not necessary for the authentication as such that different authentication procedures use the same authentication key it is possible to provide different authentication keys for different authentication procedures, i.e. for different drive units authenticating with the same or different application units. It is thus proposed that each authorization key KAₓ in the AKB encodes a different, preferably unique authentication key KRₐᵤₜₕ. As a consequence, an application unit must store not one, but multiple authentication keys KRₐᵤₜₕ when they cannot be decoded from the AKB by the application unit.

If a hacker is able to retrieve the set of node key KN_{d} from a particular drive unit, he or she can only decode one of the authentication keys KRₐᵤₜₕ of each application unit's AKB. Therefore, the effectiveness of the key publishing hack is reduced, because only a small subset of the public at large will be able to profit, i.e. namely those who have a drive that is located in the same subtree of the AKB as the hacked drive.

The hacker is forced to reveal at least part of the identity of the hacked drive: because each KRₐᵤₜₕ is unique, its position in the AKB is known, and therefore part of the hacked drive's identity which determines its path through the AKB. Therefore, all future AKBs can revoke the node keys that are on the known path. Consequently, it is possible to revoke the attacked drive in a finite number of steps: The hacker is forced to reveal at least one more bit of the drive's identity in each iteration.

It is possible to detect whether an application unit or a drive unit has been hacked: If an application unit has been hacked, it is likely that all or most of its embedded authentication keys KRₐᵤₜₕ will be published, supposedly more or less simultaneously. In this case, the application unit must be replaced by a new version, containing a new AKB. If a drive has been hacked, only one KRₐᵤₜₕ from each application unit will be published. In this case all application units must retrieve a new AKB and a new set of authentication keys KRₐᵤₜₕ, wherein the hacked drive unit or the subtree it is arranged in is revoked.

Different from the application key block known from the prior art wherein from each authorization key comprised in said application key block the same root key KRᵣₒₒₜ is to be derived an application key block according to the present invention comprises a plurality of authorization keys KAₓ wherein also a plurality of authentication keys KRₐᵤₜₕ is to be derived from this plurality of authorization keys KAₓ associated to different subsets of drive units in said application key block. Thus, different authentication keys KRₐᵤₜₕ will be used for authenticating drive units from different subset contrary to the single root key KRᵣₒₒₜ used for authentication of all drive units according to the prior art.

According to one embodiment of the system for authentication according to the present invention, said drive unit is a user device, in particular a drive, preferably an optical disc drive, and said application unit is a software application on a host computer. Key block based authentication is particularly important for a case in which data to be protected from unauthorized access is provided on a optical data carrier and is to be loaded into a computer or some other host.

In a preferred embodiment of said system for authentication according to the present invention, said identifier is a substantially unique identifier. By providing a substantially unique identifier for each drive unit it can be ensured that exactly the hacked drive unit will be identified and revoked wherein no “innocent” drive unit will be affected by the revocation.

In another embodiment of the present invention, said key block comprises a representation of a tree structure, in particular a binary tree structure, corresponding to said plurality of subsets of said drive units. By arranging the representation of the subsets in a tree structure there is a easy way to find the relevant subset in short time since the search of such a tree structure is easy and fast.

In an advantageous embodiment the system for authentication further comprises a key block generator for generating a new key block for said application unit using a previous key block, said key block generator comprising a revoking means for revoking at least one authentication key from said previous key block to form said new key block, an arranging means for arranging a plurality of subsets of drive units associated with said revoked authentication keys in substantially new subsets of drive units in said new key block and a key generation means for generating new authorization keys encoding new authentication keys for said new subsets. The key block generator is able to rearrange the entries for the plurality of non-revoked drive units in such a way that exactly this plurality is covered by the subsets for which valid authorization keys are included into the key block.

In an preferred embodiment the system for authentication according to the present invention further comprises a plurality of application units, wherein different application units each have a different key block. If there are different key blocks in the system a hacker is forced to reveal more details of the identity of the hacked drive unit in order to open up the hack to the general public.

Accordingly, it is further preferred that said key block generator is adapted for generating a different new key block for each application unit or group of application units from said previous key block.

In an advantageous embodiment of the system for authentication according to the present invention said key block generator is adapted for generating new key blocks from said previous key block, wherein different new key blocks are arranged with substantially different new subsets of drive units. With substantially different new subsets it will be achieved that a drive unit which will be hacked in the future is part of different subsets. Therefore either the number of drive units for which the hacked authorization key may be used is limited to those of one particular subset facing one particular key block or the hacker has to reveal much information as to allow the hack to be exploited by any drive unit facing any key block. Either the hack is virtually useless or the revealed information allows a rather fast tracking of said hacked drive unit.

It has to be noted that the number of iterations necessary for tracking down a hacked drive unit may be reduced by deliberately extending the AKB, i.e. “revoking” additional node keys in the upper part of the tree, so that the authorization keys KAₓ are located as near to the bottom of the tree as possible. This leads to a (possibly much) larger AKB, but the increased storage requirements do not cause a problem for application units. For example, the AKB size is only about 16 kB if all authorization keys KAₓ are 10 levels below the root of the tree. By zooming in on the attacked or hacked drive unit, i.e. by adding the additional “revocations” in the subtree that is known to contain the hacked drive unit, complete revocation may be achieved after only a few iterations. If there are multiple drives that must be traced and revoked in this fashion, the number of required iterations may increase, because the zooming-in must be performed for all of these drives at the same time. However, some efficiency may be retained when the AKBs of different popular applications are used to zoom in on different attacked drives. Even greater efficiency may be obtained if individual installations of applications contain a unique AKB, in which the additional “revocations” are e.g. randomly chosen: In this case, the hacker must reveal the lowest KAₓ present in the collection of AKBs order to open up the hack to the general public, thus giving up a substantial part of the hacked drive's identity.

In the following the present invention will be described in further detail with respect to the accompanying figures, in which:

FIG. 1 shows a tree structure of an application key block according to VCPS,

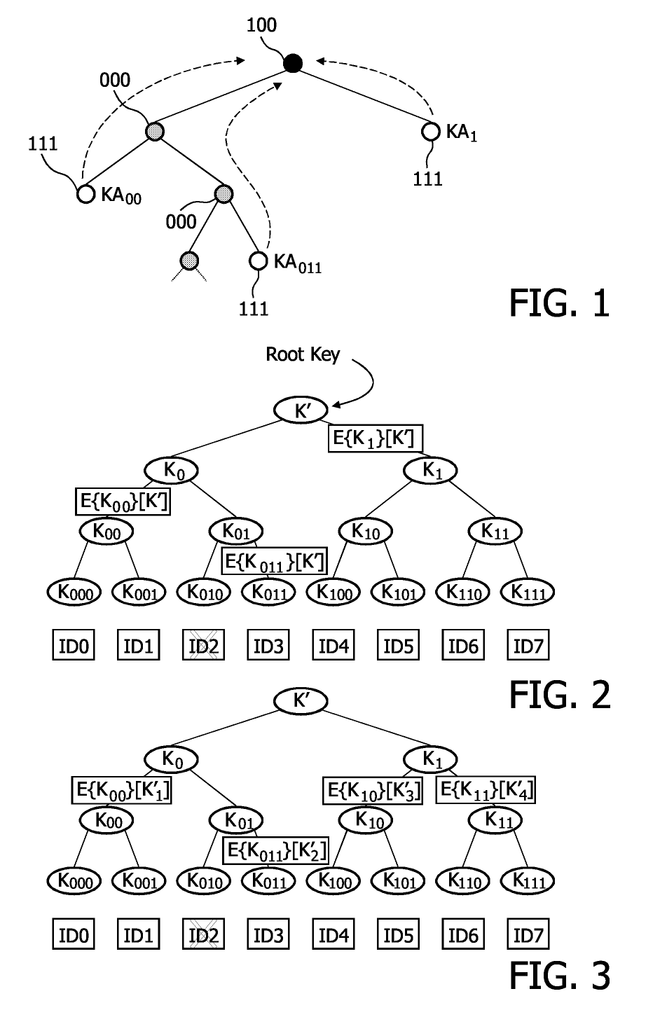

FIG. 2 shows a more detailed tree structure of an application key block according to VCPS with a revoked device,

FIG. 3 shows a tree structure of an application key block according to the present invention,

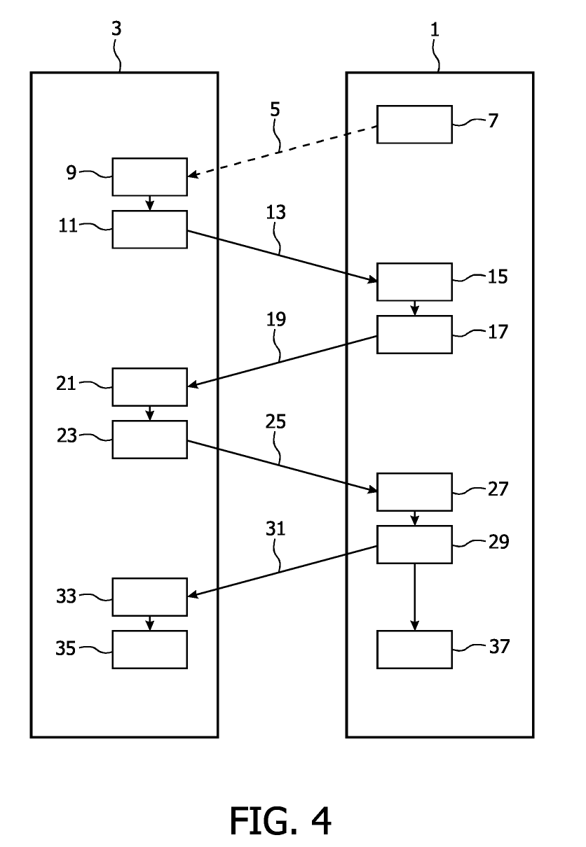

FIG. 4 shows an embodiment of the method for authentication according to the present invention,

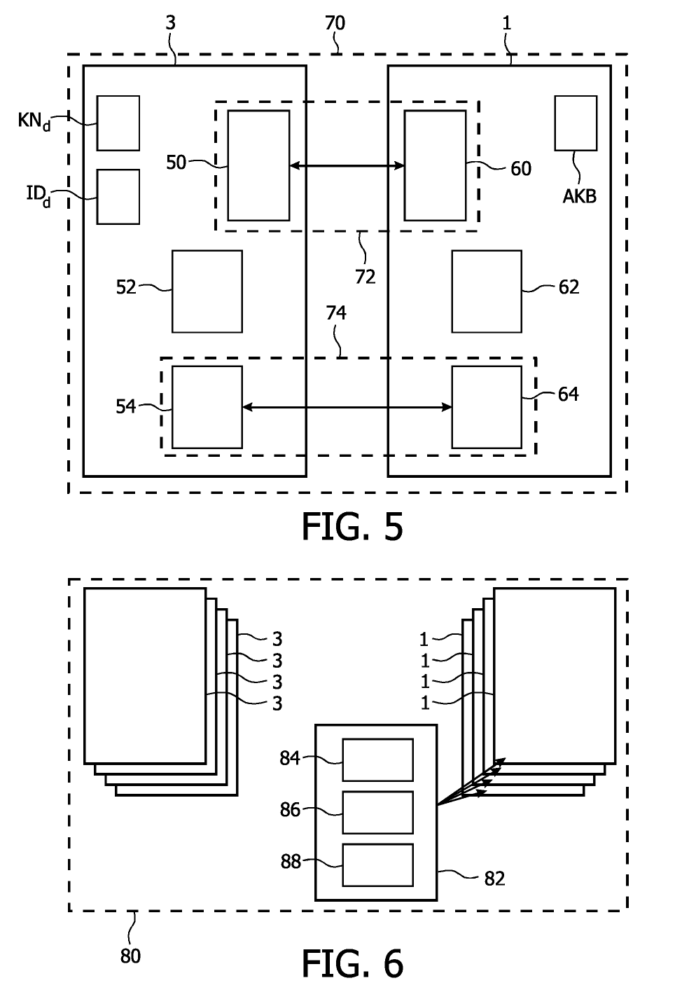

FIG. 5 shows a block diagram of a system for a key block based authentication according to the present invention and

FIG. 6 shows another embodiment of a system for a key block based authentication according to the present invention.

FIG. 1 shows an example of the top part of a known AKB. An AKB is an instance of the generic enabling key block (EKB) structure specified in the VCPS specification.

In this generic EKB, all authorization keys KAₓ encode the same root key KRᵣₒₒₜ. In the case of a VCPS DKB that is essential, because this root key is used in the key hierarchy for computing the content key, which obviously is the same for all players and recorders. However, in the case of an AKB this is not necessary. The reason is that there is no relation between different executions of the authentication protocol, and therefore the shared secret (namely KRᵣₒₒₜ) may be different.

The EKB contains a representation of a binary tree structure. The white circles and the gray circles represent the nodes of the tree. The black circle represents the root node of the tree. The node directly above a node is called its parent. A node directly below a node is called its child. The two nodes that have the same parent are called siblings. A node that does not have any children is called a leaf. All nodes that are on the (single) path from a node up to the root are called its ancestors. All nodes that are on the (multiple) paths from a node down to the leaf nodes are called its descendants. The tree that is formed by a node and all of its descendants is called a sub-tree. In FIG. 1 the white circles represent leaf nodes, and the gray circles represent parent nodes. The root node is at level 0 in the tree. The child nodes of a node at level n in the tree are at level n+1 in the tree. The EKB contains the root node and at least one leaf node.

The nodes of the EKB tree contain the following information: a three-bit tag, and optionally an authorization key KA. The tags describe the tree structure. Each node carries a tag. In FIG. 1, the underlined bit sequences left to each node indicate the tags. The tag bits have the following meaning: The leftmost tag bit is set to ‘1’ if the node is the root node or a leaf node; otherwise the leftmost tag bit is set to ‘0’. The center tag bit is set to ‘0’ if the node has a left-hand child; otherwise the center tag bit is set to ‘1’. Likewise, the rightmost tag bit is set to ‘0’ if the node has a right-hand child; otherwise the rightmost tag bit is set to ‘1’. The authorization keys KA consist of the root key KRᵣₒₒₜ decrypted with the appropriate node keys KN. Each leaf node carries a unique authorization key KA. Parent nodes do not carry an authorization key KA. In FIG. 1, KAₓ indicate the authorization keys. In this notation, the subscript x is a bit string that matches the most significant bits of one or more device IDs.

FIG. 2 shows a more detailed tree structure of an application key block according to VCPS with a revoked device. The application key block AKB is arranged in a tree-like structure wherein eight drive units ID0 to ID7 are provided. Drive unit ID2 is revoked, and accordingly said application key block is provided with three authorization keys. The tree representing the entirety of drive units is divided into three sub-trees which cover not the entirety of drive units ID0 to ID7 but the entirety of non-revoked drive units ID0, ID1 and ID3 to ID7. According to the tree structure the drive units ID0 and ID1 are contained in one sub-tree as well as ID4 to ID7 are contained in another sub-tree. The sub-tree of ID3 contains only ID3. The set of node keys KN_{d} of each drive unit comprises the node keys of the path from the root to the leaf corresponding to said drive unit. For example, drive unit ID0 is in possession of the node keys K₀, K₀₀ and K₀₀₀, and the set of node keys of drive unit ID5 comprises K₁, K₁₀ and K₁₀₁. The root key K′ used for authentication according to VCPS is contained three times in encrypted form in said key block. Each instance is an authorization key and is encrypted using a node key which is associated with one of the sub-trees of said application key block. E{K₀₀}[K′] stands for such an authorization key wherein in this case K′ is encrypted using K₀₀. Since both, drive unit ID0 and drive unit ID1, are in possession of node key K₀₀, the root key K′ can be derived from said authorization key E{K₀₀}[K′] through decryption using K₀₀. The only drive unit which is not able to obtain K′ from the authorization keys of said application key block is the revoked drive unit ID2 since it is has no access to any of the node keys used for encrypting the root key K′. However, if one of the remaining drive units is hacked and the root key K′ is made public there is no indication of which drive unit was hacked.

FIG. 3 shows a tree structure of an application key block according to the present invention. The general structure of the tree and the arrangement of the drive units is the same as shown in FIG. 2. There is still a key K′ but this key K′ is not used for authentication. According to the present invention there is no “root key” anymore, since each sub-tree encodes its own unique authentication key. The tree shown in FIG. 3 is divided into four sub-tree covering the entirety of non-revoked drive units ID0, ID1, ID3 to ID7. Each of these sub-trees has an own authorization key. The authorization keys of different sub-trees encode different authentication keys. Thus, there are different authentication keys for different sub-trees. For example, authentication key K₁′ is associated with the sub-tree of drive units ID0 and ID1 and authentication key K₄′ is associated with the sub-tree of drive units ID6 and ID7. As with the application key block shown in FIG. 3 ID2 is not able to obtain any of the authentication key K₁′ to K₄′ since none of these authentication keys is encrypted using a node key comprised in the set of node keys of drive unit ID2. Thus, drive unit ID2 is effectively revoked and not able to take part in a successful authentication process. If any of the remaining drive units is hacked, the hacker is able to obtain the corresponding authentication key K₁′, K₂′, K₃′ or K₄′. By publishing the respective authentication key the hacker will reveal at least a part of the identity of the hacked drive unit.

If, for example, drive unit ID4 would be hacked and its authentication key K₃′ would be published it would be clear that either drive unit ID4 or ID5 has been hacked. It would then be possible to change the application key block accordingly. The sub-tree of drive units ID4 and ID5 would be divided into two sub-trees wherein each new sub-tree would be provided with a new authorization key encoding a new authentication key.

If, for example, drive unit ID3 would be hacked and its authentication key K₂′ would be published it would be clear that drive unit ID3 has been hacked and thus the hacked and identified drive unit ID3 could be revoked.

As shown by the two sub-trees of drive units ID4 and ID5 and ID6 and ID7 it is possible to reduce the necessary steps of iteration to track down a hacked drive unit. By deliberately dividing a sub-tree into smaller sub-trees the number of drive units which are in the same sub-tree and share the same authentication key is thus reduced. Besides the reduction of iteration steps, i.e. the alterations of application key blocks before a hacked drive unit is identified, there is a further advantage as there is only a reduced number of drive units, i.e. those in the same sub-tree as the hacked drive unit, with which the published authentication key could be used.

FIG. 4 illustrates an embodiment of the method of authentication according to the present invention. An application unit 1 is provided with an application key block AKB containing pairs of authorization keys KAₓ and authentication keys KRₐᵤₜₕₓ (called K′ in FIG. 3). A drive unit 3 is provided with an identifier ID_{d} and a set of node keys KN_{d}. A communication between said application unit 1 and said drive unit 3 may be initiated by said application unit 1 by sending a start request 5 for an identifier of said drive unit 3 upon an initiation event 7. Said start request 5 is received by said drive 3. Step 9 of receiving and processing said start request 5 is followed by step 11 of sending an identifier message 13 containing said identifier ID_{d} identifying said drive unit 3 to said application unit 1. Alternatively, the protocol may also be initiated by said drive unit 3 by sending said identifier ID_{d} without a start request 5 from said application unit 1. In step 15 said identifier ID_{d} is used by said application unit 1 to locate the pair of authorization key KAₓ and authentication key KRₐᵤₜₕₓ for the drive unit 3 in the AKB. If said drive unit 3 is not authorized, e.g. if there is no authorization key KAₓ or no authentication key KRₐᵤₜₕₓ for said drive unit 3, said application unit 1 will abort the authentication protocol.

In step 17 said application unit 1 generates and transmits a message 19 including said authorization key KAₓ, an indicator j indicating the position of said authorization key KAₓ in said AKB and a random host number RA. Said drive unit 3 obtains (step 21) said authentication key KRₐᵤₜₕₓ by means of said authorization key KAₓ and a node key KN_{E} of said set of node keys KN_{d} associated to said indicator j. In step 23 said drive unit 3 generates a random drive number RD and a drive key contribution QD and sends a message 25 including said host number RA, said drive number RD and said key contribution QD being encrypted using said authentication key KRₐᵤₜₕₓ to said application unit 1. Said application unit 1 decrypts said message 25 and checks for the presence of the correct host number RA in said message 25 (step 27). If said host number RA is not identical to the value of step 17 the authentication protocol is aborted.

In step 29 a host key contribution QA is generated and a message 31 is sent to said drive including said drive number RD, said host number RA and said host key contribution QA being encrypted using said authentication key KRₐᵤₜₕₓ. In step 33 said drive 3 decrypts said message 31 and checks for the presence of the correct drive number RD in said message 31. If said drive number RD is not identical to the value of step 23 the authentication protocol is aborted.

In steps 35 and 37 a bus key KB is generated from said drive key contribution QD and said host key contribution QA. Said bus key KB is now a secret shared by both, the application unit 1 and drive unit 3, wherein said authentication between said application unit 1 and said drive unit 3 was successful. In case the authentication protocol is aborted it has to be started again at step 7 or step 11, respectively.

FIG. 5 shows a block diagram of a system 70 for a key block based authentication according to the present invention comprising an application unit 1 and a drive unit 3. Said application unit 1 is provided with an application key block AKB having pairs of authorization and authentication keys. Said application unit 1 further comprises a communication means 60, a selecting means 62 and an authentication means 64. Said drive unit 3 is provided with a set of node keys KN_{d} and an identifier ID_{d}. Said drive unit 3 further comprises a communication means 50, a decoding means 52 and an authentication means 54. Said communication means 50, 60 are part of the communication means 72 of said system 70 and said authentication means 54, 64 are part of the authentication means 74 of said system 70.

Said identifier ID_{d} is transmitted from said drive unit 3 to said application unit 1 by means of said communication means 72. Said selecting means 62 is used to select a pair of an authorizations key KAₓ and an authentication key KRₐᵤₜₕₓ from said AKB. Said authorization key KAₓ is transmitted from said application unit 1 to said drive unit 3 where said decoding means 52 is used to derive said authentication key KRₐᵤₜₕₓ from said authorization key KAₓ by means of said set of node keys KN_{d}. An authentication is performed using said authentication means 74 as described above with regard to FIG. 4.

FIG. 6 shows another embodiment of a system 80 for a key block based authentication according to the present invention. The system 80 comprises a plurality of application units 1 and a plurality of drive units 3 as described above. The details of said application units and said drive units are not shown for clarity's sake. Said system 80 further comprises a key block generator 82 having revoking means 84, arranging means 86 and key generation means 88. Said key block generator 82 generates a new key block AKB for said application units 1 using a previous key block. Using said revoking means 84 and said arranging means 86 an authentication key and the associated authorization key is removed from said key block for revoking a subset of drive units 3 and the entries corresponding to the drive units of said subset which shall not be revoked are arranged in new subsets for which new pairs of authorization and authentication keys are generated using said key generation means. The new key blocks are then distributed to said application units 1 or used for new application units 1.

According to the present invention a new key block based authentication method and a corresponding new key block based authentication system are proposed. By providing different authentication keys for different drive units the effect of a hacked drive unit is reduced, i.e. the usability of an authentication key obtained by hacking is reduced, and an identification of such an hacked drive unit is made possible in order to facilitate a revoking of a hacked drive unit.

The present invention is to a large extent compatible with the known VCPS authentication protocol. Neither hardware nor command set modifications are required for implementing the present invention into said protocol. It is fully backwards compatible with the current version of the specification. What must be changed, however, are the key generation and key issuance tools, and the interface of the key issuance center to the software manufacturers. Of course, software manufacturers must adapt as well.

It has to be noted that the present invention is not limited to the described VCPS since it may be used with other optical formats, such as Blu-ray Disc, and is also applicable to other key block formats and authentication protocols based thereon, such as those used by CPRM and AACS.

1. System (70, 80) for a key block based authentication comprising:
a plurality of drive units (3) comprising a plurality of subsets, wherein a drive unit (3) has a set of node keys (KN_{d}) and an identifier (ID_{d}) indicating the subsets said drive unit (3) is part of,
an application unit (1) having a key block (AKB) comprising a plurality of pairs of authorization and authentication keys (KAₓ, KRₐᵤₜₕₓ), wherein each pair of keys is associated with one of said subsets and comprises a different authentication key (KRₐᵤₜₕ),
a communication means (72) for submitting said identifier (ID_{d}) from said drive unit (3) to said application unit (1) and for submitting an authorization key (KAₓ) from said application unit (1) to said drive unit (3), and
an authentication means (54) for authenticating said drive unit (3) and said application unit (1) by means of a pair of keys,
wherein said application unit (1) comprises a selecting means (62) for selecting said pair of keys from said key block (AKB) corresponding to said identifier (ID_{d}),
wherein said drive unit (3) comprises a decoding means (52) for deriving said authentication key (KRₐᵤₜₕₓ) of said pair of keys from said authorization key (KAₓ) of said pair of keys by means of said set of node keys (KN_{d}).

2. System (70, 80) for authentication as claimed in claim 1, wherein said drive unit (3) is a user device, in particular a drive, preferably an optical disc drive, and said application unit (1) is a software application on a host computer.

3. System (70, 80) for authentication as claimed in claim 1, wherein said identifier (ID_{d}) is a substantially unique identifier.

4. System (70, 80) for authentication as claimed in claim 1, wherein said key block (AKB) comprises a representation of a tree structure, in particular a binary tree structure, corresponding to said plurality of subsets of said drive units (3).

5. System (70, 80) for authentication as claimed in claim 1,
further comprising a key block generator (82) for generating a new key block for said application unit (1) using a previous key block, said key block generator (82) comprising:
a revoking means (84) for revoking at least one authentication key from said previous key block to form said new key block,
an arranging means (86) for arranging a plurality of subsets of drive units (3) associated with said revoked authentication keys in substantially new subsets of drive units (3) in said new key block,
a key generation means (88) for generating new authorization keys encoding new authentication keys for said new subsets.

6. System (70, 80) for authentication as claimed in claim 1,
further comprising a plurality of application units (1), wherein different application units (1) each have a different key block (AKB).

7. System (70, 80) for authentication as claimed in claim 5,
further comprising a plurality of application units (1), wherein said key block generator (88) is adapted for generating a different new key block for each application unit (1) or group of application units (1) from said previous key block.

8. System (70, 80) for authentication as claimed in claim 7,
wherein said key block generator (82) is adapted for generating new key blocks from said previous key block, wherein different new key blocks are arranged with substantially different new subsets of drive units (3).

9. Drive unit (3) of a system (70, 80) for a key block based authentication, wherein said system (70, 80) comprises a plurality of drive units (3) comprising a plurality of subsets and an application unit (1), said drive unit (3) comprising:
a set of node keys (KN_{d}),
an identifier (ID_{d}) indicating the subsets said drive unit (3) is part of,
a communication means (50) for submitting said identifier (ID_{d}) to said application unit (1) and for receiving an authorization key (KAₓ) from said application unit (1), said application unit (1) comprising a key block (AKB) comprising a plurality of pairs of authorization and authentication keys (KA, KRₐᵤₜₕₓ), wherein each pair of keys is associated with one of said subsets of said drive units (3) and comprises a different authentication key (KRₐᵤₜₕₓ),
a decoding means (52) for deriving an authentication key (KRₐᵤₜₕₓ) from said authorization key (KAₓ) by means of said set of node keys (KN_{d}), and
an authentication means (54) for authenticating said application unit (1) by means of said authentication key (KRₐᵤₜₕₓ).

10. Application unit (1) of a system (70, 80) for a key block based authentication, wherein said system further comprises a plurality of drive units (3) comprising a plurality of subsets, said application unit (1) comprising:
a key block (AKB) comprising a plurality of pairs of authorization and authentication keys (KA_{X}, KRₐᵤₜₕₓ), wherein each pair of keys is associated with one of said subsets of said drive units (3) and comprises a different authentication key (KRₐᵤₜₕₓ),
a communication means (60) for receiving an identifier (ID_{d}) from a drive unit (3) and for submitting an authorization key (KA_{X}) to said drive unit (3),
a selecting means (62) for selecting a pair of keys from said key block corresponding to said identifier (ID_{d}),
an authentication means (64) for authenticating said drive unit (3) by means of an authentication key (KRₐᵤₜₕₓ).

11. Method for a key block based authentication between
a drive unit (3) of a plurality of drive units (3), said plurality comprising a plurality of subsets, said drive unit (3) having a set of node keys (KN_{d}) and an identifier (ID_{d}) indicating the subset said drive unit (3) is part of, and
an application unit (1) having a key block (AKB) comprising a plurality of pairs of authorization and authentication keys (KA_{X}, KRₐᵤₜₕₓ), wherein each pair of keys is associated with one of said subsets and comprises a different authentication key (KRₐᵤₜₕₓ),
said method comprising the steps of:
submitting (11) said identifier (ID_{d}) to said application unit (1),
selecting (15) a pair of keys from said key block (AKB) corresponding to said identifier (ID_{d}),
submitting (17) the authorization key (KAₓ) of said pair of keys to said drive unit (3),
wherein said drive unit (3) derives (21) the authentication key (KRₐᵤₜₕₓ) of said pair of keys from said authorization key (KAₓ) using said set of node keys (KN_{d}) and said authentication is performed using said authentication key (KRₐᵤₜₕ).

12. A computer program comprising computer program code means for causing a computer to perform the steps of the method as claimed in claim 11 when said computer program is run on a computer.
